(19) United States
(12) Patent Application Publication
(10) Pub. No.: US 2016/0343059 A1
(43) Pub. Date: Nov. 24, 2016

(54) RECOMMENDATION APPARATUS, RECOMMENDATION METHOD, AND RECOMMENDATION MEDIUM PRODUCING METHOD

(71) Applicant: Scigineer, Inc., Tokyo (JP)

(72) Inventor: Shinichiro YOSHII, Tokyo (JP)

(21) Appl. No.: 15/111,264

(22) PCT Filed: Jan. 27, 2015
(86) PCT No.: PCT/JP2015/052184

§ 371 Date: Jul. 13, 2016

(30) Foreign Application Priority Data
Jan. 28, 2014 (JP) 2014-012907

(51) Int. Cl. G06Q 30/06

(52) U.S. Cl. CPC G06Q 30/0631; G06Q 30/0623

(57) ABSTRACT

In order to solve a problem that conventional recommendation apparatuses cannot effectively recommend products, a recommendation apparatus includes: a receiving unit that receives a purchase instruction having a user identifier and a product identifier that is to be purchased; a purchase information generating unit that generates purchase information, which is information related to a purchase of a product; a recommendation information acquiring unit that acquires one or more pieces of recommendation information, which is information related to a product that is to be recommended to the user; and an output unit that outputs the purchase information and the one or more pieces of recommendation information in association with each other, wherein the output unit outputs the one or more pieces of recommendation information to a medium that is different from a medium to which the purchase instruction was input. Accordingly, it is possible to effectively recommend products.

### TECHNICAL FIELD

The present invention relates to a recommendation apparatus and the like for accepting an instruction to purchase a product or the like, and generating and outputting one or more pieces of recommendation information.

### BACKGROUND ART

Conventionally, there have been recommendation apparatuses that recommend a product or the like based on purchasing behavior (see Patent Document 1, for example).

### CITATION LIST

### Patent Document

Patent Document 1: JP 2012-247926A (p. 1, FIG. 1 etc.)

### SUMMARY OF INVENTION

### Technical Problem

However, conventional recommendation apparatuses cannot effectively recommend products.

Moreover, specifically, conventional recommendation apparatuses cannot output recommendation information to a medium (e.g., a paper medium, etc.) that is different from a medium (typically, a webpage) to which a purchase instruction was input. Furthermore, conventional recommendation apparatuses cannot print a purchase identifier such as an order number and one or more pieces of recommendation information in association with each other.

### Solution to Problem

A first aspect of the present invention is directed to a recommendation apparatus including: a receiving unit that receives a purchase instruction having a user identifier for identifying a user and a product identifier for identifying a product that is to be purchased; a purchase information generating unit that generates purchase information, which is information related to a purchase of a product, using the purchase instruction; a recommendation information acquiring unit that acquires one or more pieces of recommendation information, which is information related to a product that is to be recommended to the user, using the purchase instruction; and an output unit that outputs the purchase information and the one or more pieces of recommendation information in association with each other.

With this configuration, it is possible to effectively recommend products.

Furthermore, a second aspect of the present invention is directed to the recommendation apparatus according to the first aspect, wherein the output unit outputs the one or more pieces of recommendation information to a medium that is different from a medium to which the purchase instruction was input.

With this configuration, it is possible to effectively recommend products. The probability of the one or more pieces of recommendation information being seen by the user is high.

Furthermore, a third aspect of the present invention is directed to the recommendation apparatus according to the first or second aspect, wherein the purchase information generating unit generates purchase information containing a purchase identifier for identifying a purchase of a product corresponding to the purchase instruction, and the output unit outputs the purchase identifier and the one or more pieces of recommendation information in association with each other.

With this configuration, it is possible to effectively recommend products.

Furthermore, a fourth aspect of the present invention is directed to the recommendation apparatus according to the third aspect, wherein the output unit prints the purchase identifier and the one or more pieces of recommendation information, on the same sheet of paper.

With this configuration, it is possible to effectively recommend products. The sheet of paper on which the recommendation information is printed is packed together with the product, and the probability of being seen by the user is extremely high.

Furthermore, a fifth aspect of the present invention is directed to the recommendation apparatus according to any one of the first to fourth aspects, wherein the recommendation information contains a code indicating information for identifying a product.

With this configuration, it is possible to effectively recommend products.

Furthermore, a sixth aspect of the present invention is directed to the recommendation apparatus according to the fifth aspect, wherein the code includes one or more types of information, among information indicating that a medium is an output medium, which is a medium to which recommendation information is to be output, an output medium identifier for identifying an output medium to which recommendation information is to be output, a purchase information identifier for identifying purchase information, and a user identifier for identifying a user, and in a case where the code is read, a webpage for purchasing a product corresponding to the code is output.

With this configuration, it is possible to effectively recommend products, thereby prompting the user to purchase the products.

Furthermore, a seventh aspect of the present invention is directed to the recommendation apparatus according to any one of the first to sixth aspects, wherein the recommendation apparatus further includes: a delivery information generating unit that generates delivery information, which is information related to a delivery, using the purchase instruction, and the output unit outputs the purchase identifier and the one or more pieces of recommendation information in association with each other, and outputs the delivery information.

With this configuration, it is possible to effectively recommend products.

Advantageous Effects of Invention

With the recommendation apparatus according to the present invention, it is possible to effectively recommend products.

### BRIEF DESCRIPTION OF DRAWINGS

FIG. 1 is a conceptual diagram of a recommendation system according to Embodiment 1.

FIG. 2 is a block diagram of the recommendation system of the embodiment.

FIG. 3 is a flowchart illustrating an operation of a recommendation apparatus 1 of the embodiment.

FIG. 4 is a flowchart illustrating recommendation information acquiring processing of the embodiment.

FIG. 5 is a diagram showing a product information management table of the embodiment.

FIG. 6 is a diagram showing a user information management table of the embodiment.

FIG. 7 is a diagram showing a purchase information management table of the embodiment.

FIG. 8 is a diagram showing an example of a recommendation medium of the embodiment.

FIG. 9 is a diagram showing an example of a recommendation medium of the embodiment.

FIG. 10 is a diagram showing an example of a recommendation medium of the embodiment.

FIG. 11 is a schematic view of a computer system in the foregoing embodiment.

FIG. 12 is a block diagram of the computer system of the embodiment.

### DESCRIPTION OF EMBODIMENT

Hereinafter, an embodiment of a recommendation apparatus and the like will be described with reference to the drawings. It should be noted that constituent elements denoted by the same reference numerals in the embodiment perform similar operations, and thus a description thereof may not be repeated.

### Embodiment 1

In this embodiment, a recommendation system for accepting an instruction to purchase a product, and generating and outputting one or more pieces of recommendation information in association with purchase information will be described. Note that, in this specification, it is assumed that a product refers to an item that is purchased, and is to be broadly interpreted so as to encompass a service and the like. The purchase information typically includes a purchase identifier (e.g., an order number).

Furthermore, in this embodiment, a recommendation system for outputting one or more pieces of recommendation information to a medium (e.g., paper) that is different from a medium (e.g., a webpage) to which a purchase instruction was input will be described.

Furthermore, in this embodiment, a recommendation system for generating a purchase identifier (e.g., an order number) and outputting the purchase identifier together with one or more pieces of recommendation information will be described. In this case, “output together” refers to, for example, printing the purchase identifier and the one or more pieces of recommendation information, on the same sheet of paper. Note that the same sheet of paper may be two or more sheets of paper.

Furthermore, in this embodiment, a recommendation system for outputting a code (e.g., a QR code (registered trademark)) in association with recommendation information that is to be output will be described. Note that the code includes, for example, one or more types of information, among information indicating that a medium is an output medium, an output medium identifier for uniquely identifying each output medium, a purchase information identifier for identifying purchase information, and a user identifier for identifying a user.

Moreover, in this embodiment, a recommendation system for outputting delivery information together with one or more pieces of recommendation information will be described.

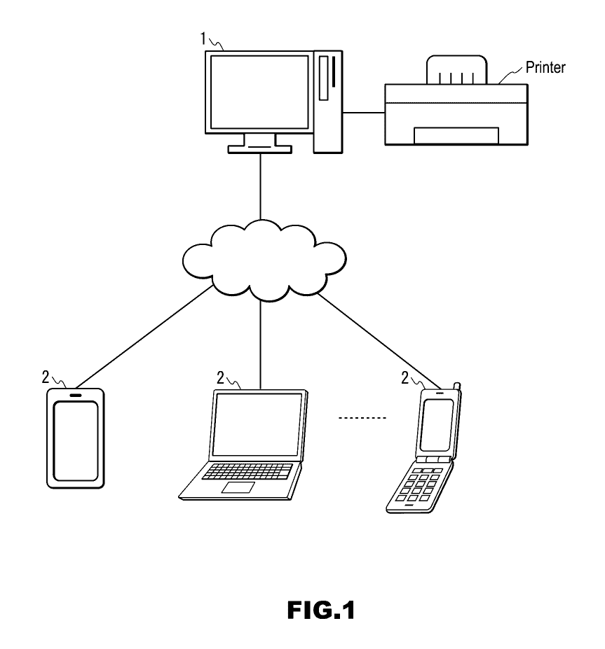

FIG. 1 is a conceptual diagram of a recommendation system in this embodiment. The recommendation system includes a recommendation apparatus 1 and one or more terminal apparatuses 2. The recommendation apparatus 1 is an apparatus that outputs recommendation information. Each terminal apparatus 2 is a terminal of a user who purchases a product, and is, for example, a so-called smartphone, mobile phone, mobile terminal, personal computer, laptop, tablet device, or the like.

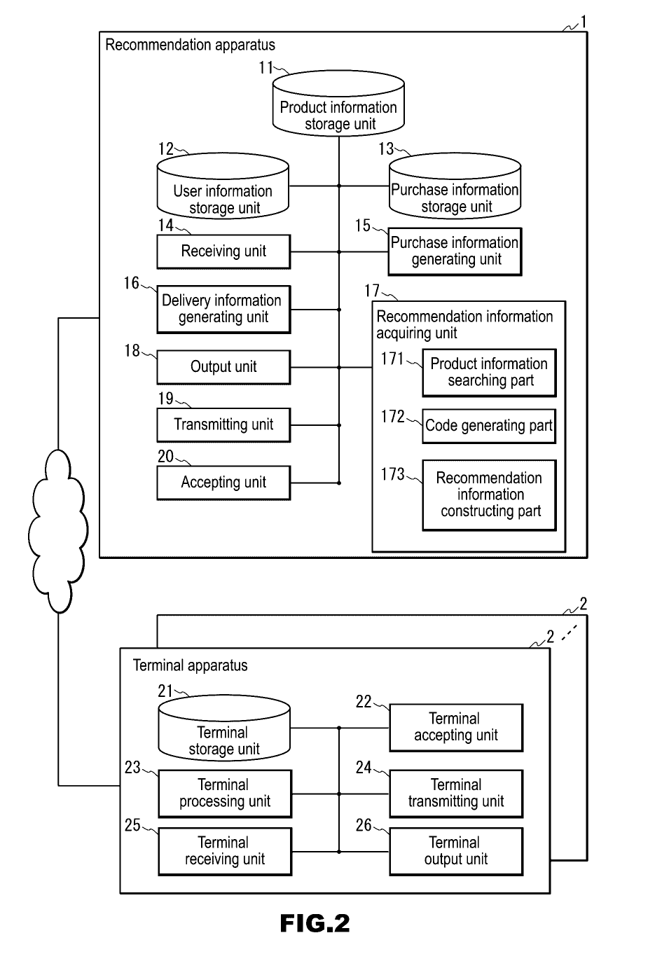

FIG. 2 is a block diagram of the recommendation system in this embodiment.

The recommendation apparatus 1 includes a product information storage unit 11, a user information storage unit 12, a purchase information storage unit 13, a receiving unit 14, a purchase information generating unit 15, a delivery information generating unit 16, a recommendation information acquiring unit 17, an output unit 18, a transmitting unit 19, and an accepting unit 20.

The recommendation information acquiring unit 17 includes a product information searching part 171, a code generating part 172, and a recommendation information constructing part 173.

Each terminal apparatus 2 includes a terminal storage unit 21, a terminal accepting unit 22, a terminal processing unit 23, a terminal transmitting unit 24, a terminal receiving unit 25, and a terminal output unit 26.

In the product information storage unit 11 forming the recommendation apparatus 1, one or more pieces of product information can be stored. The product information is information related to a product. The product information has, for example, a product identifier for identifying a product, a product name, a price (unit price), a product attribute value (e.g., color, size, production area, material, shape, etc.), a product photo, a product image, and the like. The product identifier may be referred to as, for example, a product number or a product ID.

In the user information storage unit 12, one or more pieces of user information, which is information related to a user, can be stored. The user information has, for example, a user identifier, full name, age, address, telephone number, facsimile number, e-mail address, credit card number, interests, and the like.

In the purchase information storage unit 13, one or more pieces of purchase information can be stored. The purchase information is information related to a purchase of a product. The purchase information typically has a user identifier and a product identifier. The purchase information may have the quantity of purchased products, purchase price, credit card number, date of purchase, time and date of purchase. The purchase information may be referred to as information indicating that the act of purchasing a product was performed. In the purchase information storage unit 13, one or more pieces of recommendation information may be stored in association with the purchase information. The recommendation information will be described later in detail.

The receiving unit 14 receives a purchase instruction from the terminal apparatuses 2. The purchase instruction is an instruction to purchase a product. The purchase instruction typically has a user identifier and a product identifier of a product that is to be purchased. The receiving unit 14 may receive all pieces of information forming a purchase instruction at a time, or may receive information forming a purchase instruction in two or more divided pieces.

The purchase information generating unit 15 generates purchase information, using the purchase instruction received by the receiving unit 14. The purchase information generating unit 15 constructs, for example, purchase information containing the product identifier and the quantity contained in the purchase instruction. The purchase information generating unit 15 may, for example, generate a unique purchase identifier, and construct purchase information having that purchase identifier and information such as the product identifier contained in the purchase instruction. The purchase identifier is information for identifying an order, and is, for example, an order identifier such as an order number. For example, the purchase information generating unit 15 acquires a unit price from the product information storage unit 11, using, as a key, the product identifier contained in the purchase instruction, calculates a purchase price using that unit price and the quantity, and constructs purchase information containing that purchase price, the product identifier, and the user identifier. There is no limitation on the algorithm by which the purchase information generating unit 15 generates purchase information.

The delivery information generating unit 16 generates delivery information, which is information related to a delivery, using the purchase instruction. Note that to use the purchase instruction is to use a product identifier or the like forming a purchase instruction. The delivery information is information that forms a delivery slip. The delivery information generating unit 16 inserts, for example, part of the purchase information into a delivery slip form, thereby generating information that forms a delivery slip. Note that it is assumed that the delivery slip form is held by the delivery information generating unit 16. The delivery information is typically information that forms a delivery slip, but may be information forming a document similar to a delivery slip, such as information forming an invoice, billing statement, quotation, or the like.

The recommendation information acquiring unit 17 acquires one or more pieces of recommendation information, which is information related to a product that is to be recommended to the user, using the purchase instruction. Note that “using the purchase instruction” may be using information contained in the purchase instruction, may be acquiring one or more pieces of recommendation information in response to receiving a purchase instruction, or may be associating one or more pieces of recommendation information with the purchase instruction, for example.

There is no limitation on the algorithm by which the recommendation information acquiring unit 17 acquires one or more pieces of recommendation information. The recommendation information acquiring unit 17 may use a well-known recommendation algorithm such as collaborative filtering, or may use the algorithm described in Japanese Patent Application No. 2007-052708 or the like. Note that it is preferable that the recommendation information acquiring unit 17 acquires recommendation information unique to the user, using the user information containing user attributes such as user's age, sex, and interests, the user's purchase history, or purchase information.

The recommendation information acquiring unit 17 may select one or more pieces of product information from the product information storage unit 11 included in the recommendation apparatus 1, or may receive one or more pieces of product information from an external product information server. If one or more pieces of product information are received from an external product information server, the recommendation apparatus 1 does not need to have the product information storage unit 11.

Furthermore, the recommendation information may contain a code indicating information for identifying a product. The code is, for example, a QR code (registered trademark), a bar code, or the like. There is no limitation on the type of code. It is preferable that the code includes, for example, one or more types of information, among information indicating that a medium is an output medium, which is a medium to which recommendation information is to be output, an output medium identifier for identifying an output medium to which recommendation information is to be output, a purchase information identifier for identifying purchase information, and a user identifier. If the code is read, a webpage for purchasing a product corresponding to the code is output. If the product is purchased from that webpage, the purchase instruction typically includes information held by the code (one or more types of information, among information indicating that a medium is an output medium, an output medium identifier, a purchase information identifier, and a user identifier, etc.). The information indicating that a medium is an output medium is, for example, information indicating that a medium is a paper medium.

The product information searching part 171 forming the recommendation information acquiring unit 17 acquires one or more pieces of product information, using the purchase instruction. There is no limitation on the algorithm by which the product information searching part 171 acquires one or more pieces of product information. The product information searching part 171 may use a well-known recommendation algorithm such as collaborative filtering, or may use the algorithm described in Japanese Patent Application No. 2007-052708 or the like. Note that it is preferable to acquire recommendation information unique to the user, using the user information containing user attributes such as user's age, sex, and interests, the user's purchase history, or purchase information. The product information searching part 171 may acquire, for example, product information of another product that has the same attribute value as the attribute value of a product identified by the product identifier contained in the purchase instruction. The product information searching part 171 may acquire, for example, product information of another product purchased by another user who purchased a product identified by the product identifier contained in the purchase instruction. For example, using the purchase history of the user and the purchase histories of other users, the product information searching part 171 may select another user whose preference matches the preference of that user, and acquire product information of another product purchased by the other user.

Furthermore, the product information searching part 171 may select one or more pieces of product information from the product information storage unit 11 included in the recommendation apparatus 1, or may receive one or more pieces of product information from an external product information server.

The code generating part 172 generates a code indicating information for identifying a product. The code generating part 172 typically generates a code for each of the one or more pieces of product information acquired by the product information searching part 171. For example, the code generating part 172 reads information indicating that a medium is an output medium, which is a medium (e.g., paper) to which the recommendation information is to be output, and generates a code in which that information is embedded. In this case, in the code generating part 172, the information indicating that a medium is an output medium is stored. For example, the code generating part 172 generates an output medium identifier for identifying an output medium to which the recommendation information is to be output, and generates a code in which that output medium identifier is embedded. The code generating part 172 generates, for example, a code in which the purchase information identifier generated by the purchase information generating unit 15 is embedded. For example, the code generating part 172 acquires a user identifier corresponding to the purchase instruction, and generates a code in which that user identifier is embedded. The code generating part 172 generates, for example, a code in which a product identifier contained in the product information acquired by the product information searching part 171 is embedded.

The recommendation information constructing part 173 constructs one or more pieces of recommendation information, using the one or more pieces of product information acquired by the product information searching part 171. The recommendation information constructing part 173 constructs one or more pieces of recommendation information, using the one or more pieces of product information acquired by the product information searching part 171 and the one or more codes generated by the code generating part 172. The recommendation information generated by the recommendation information constructing part 173 may contain no code. In this case, the code generating part 172 is not necessary. The recommendation information constructing part 173 may construct a file (e.g., a PDF file) containing one or more pieces of recommendation information.

The output unit 18 outputs the purchase information and the one or more pieces of recommendation information in association with each other. The output is typically printing. Note that the output may be transmitting a file (e.g., a PDF file) having one or more pieces of recommendation information by e-mail to the user who transmitted the purchase instruction. There is no limitation on the form of association, in the output with association. For example, the output unit 18 prints the purchase identifier and the one or more pieces of recommendation information, on the same sheet of paper. The sheet of paper is typically packed together with the product. At that time, a packing operator can correctly pack the sheet of paper on which the recommendation information for the user who purchased a product is printed, together with that product, based on the purchase identifier.

That is to say, the output in which the purchase information and the one or more pieces of recommendation information are associated with each other is printing the purchase information and the one or more pieces of recommendation information, on the same sheet of paper. The same sheet of paper may be two or more sheets. The output in which the purchase information and the one or more pieces of recommendation information are associated with each other may be recording the purchase information and the one or more pieces of recommendation information, in one file.

Furthermore, it is preferable that the output unit 18 outputs the one or more pieces of recommendation information to a medium that is different from a medium to which the purchase instruction was input. Typically, the medium to which the purchase instruction was input is a webpage or a website. The medium that is different from a medium (e.g., a webpage) to which a purchase instruction was input is, for example, a printer, a facsimile machine, or the like. The medium is a medium to which the output is to be performed, and is, for example, a webpage, a website, a printer, a facsimile machine, or the like.

The output unit 18 may output a file having one or more pieces of recommendation information. In this case, the output unit 18 may transmit that file (e.g., a PDF file) as an attached file by e-mail to the user who input the purchase instruction.

Furthermore, it is preferable that the output unit 18 once prints the accumulated one or more pieces of recommendation information together with the purchase identifier. It is preferable that the output unit 18 prints the purchase identifier and the one or more pieces of recommendation information, on the same sheet of paper.

Furthermore, it is preferable that the output unit 18 outputs the purchase identifier and the one or more pieces of recommendation information in association with each other, and outputs the delivery information.

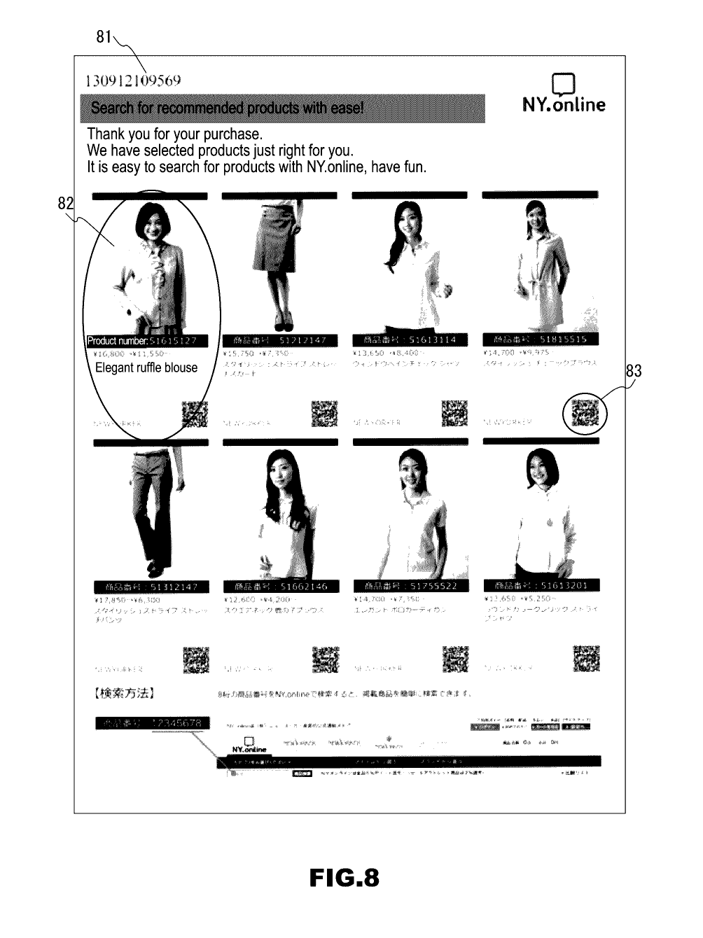

Furthermore, it is preferable that the output unit 18 prints the purchase information and the one or more pieces of recommendation information in association with each other, thereby producing a recommendation medium that is a sheet of paper on which the one or more pieces of recommendation information are printed. FIGS. 8 to 10, which will be described later, show an example of the recommendation medium.

There is no limitation on the time when the output unit 18 outputs the purchase information and the one or more pieces of recommendation information in association with each other. Note that it is preferable that the output unit 18 outputs the one or more pieces of recommendation information and the like at a time that is different from the time when the purchase instruction is received. In this case, the output unit 18 outputs the one or more pieces of recommendation information and the like, in the case where the accepting unit 20 accepts an output instruction. The output instruction is, for example, a print instruction to print the purchase identifier, the one or more pieces of recommendation information, and the like, a transmission instruction to transmit a file (e.g., PDF) having the purchase identifier, the one or more pieces of recommendation information, and the like by e-mail to the user who transmitted the purchase instruction, or the like. It is preferable that the output instruction has the purchase identifier.

Note that the output unit 18 may output the one or more pieces of recommendation information and the like, in the case where the purchase instruction is received.

The transmitting unit 19 transmits information to the terminal apparatuses 2. The information is, for example, a webpage for purchasing a product. The webpage is held by an unshown storage unit. For example, if the accepting unit 20 accepts an instruction to acquire a webpage, the transmitting unit 19 transmits information to the corresponding terminal apparatus 2.

The accepting unit 20 accepts an instruction and the like. The instruction and the like are, for example, an instruction to output one or more pieces of recommendation information and the like. The output instruction is, for example, a print instruction, a transmission instruction, or the like, as described above. The print instruction and the like may be input via any part such as a keyboard, a mouse, a touch panel, a menu screen, or the like. The terminal accepting unit 22 may be realized by a device driver for an input part such as a keyboard, control software for a menu screen, or the like.

In the terminal storage unit 21 forming the terminal apparatus 2, information and the like can be stored. The information and the like are, for example, a user identifier.

The terminal accepting unit 22 accepts instructions and information from the user. The instructions and information are, for example, an instruction to acquire a webpage for purchasing a product. The instructions and information are, for example, a purchase instruction. There is no limitation on the content of the information and the instructions accepted by the terminal accepting unit 22. The information accepted by the terminal accepting unit 22 is, for example, a product identifier of a product that is to be purchased, the quantity thereof, and the like. The instructions, the information, and the like may be input via any part such as a keyboard, a mouse, a touch panel, a menu screen, or the like. The terminal accepting unit 22 may be realized by a device driver for an input part such as a keyboard, control software for a menu screen, or the like.

The terminal processing unit 23 constructs a purchase instruction, from the product identifier, the quantity, and the like accepted by the terminal accepting unit 22.

The terminal transmitting unit 24 transmits the purchase instruction accepted by the terminal accepting unit 22 or the purchase instruction generated by the terminal processing unit 23, to the recommendation apparatus 1.

The terminal receiving unit 25 receives information. The information is, for example, a webpage for purchasing a product. The webpage may be received from the recommendation apparatus 1, or may be received from another apparatus.

The terminal output unit 26 outputs the information received by the terminal receiving unit 25. The information is, for example, a webpage for purchasing a product. The output is typically a display on a display screen, but is a concept that encompasses projection using a projector, printing by a printer, output of a sound, transmission to an external apparatus, accumulation in a storage medium, delivery of a processing result to another processing apparatus or another program, and the like.

The product information storage unit 11, the user information storage unit 12, the purchase information storage unit 13, and the terminal storage unit 21 are preferably non-volatile storage media, but may also be realized by volatile storage media.

There is no limitation on the procedure in which the product information and the like are stored in the product information storage unit 11 and the like. For example, the product information and the like may be stored in the product information storage unit 11 and the like via a storage medium, the product information and the like transmitted via a communication line or the like may be stored in the product information storage unit 11 and the like, or the product information and the like input via an input device may be stored in the product information storage unit 11 and the like.

The receiving unit 14 and the terminal receiving unit 25 are realized typically by a wireless or wired communication part, but may also be realized by a broadcast receiving part.

The purchase information generating unit 15, the delivery information generating unit 16, the recommendation information acquiring unit 17, and the terminal processing unit 23 may be realized typically by an MPU, a memory, or the like. Typically, the processing procedure of the purchase information generating unit 15 is realized by software, and the software is stored in a storage medium such as a ROM. Note that the processing procedure may also be realized by hardware (a dedicated circuit).

The output unit 18 may be considered to include or to not include an output device such as a printer or a display screen. The output unit 18 may be realized, for example, by driver software for an output device, a combination of driver software for an output device and the output device, or the like.

The transmitting unit 19 and the terminal transmitting unit 24 are realized typically by a wireless or wired communication part, but may also be realized by a broadcasting part.

The terminal output unit 26 may be considered to include or to not include an output device such as a display screen or a speaker. The terminal output unit 26 may be realized by driver software for an output device, a combination of driver software for an output device and the output device, or the like.

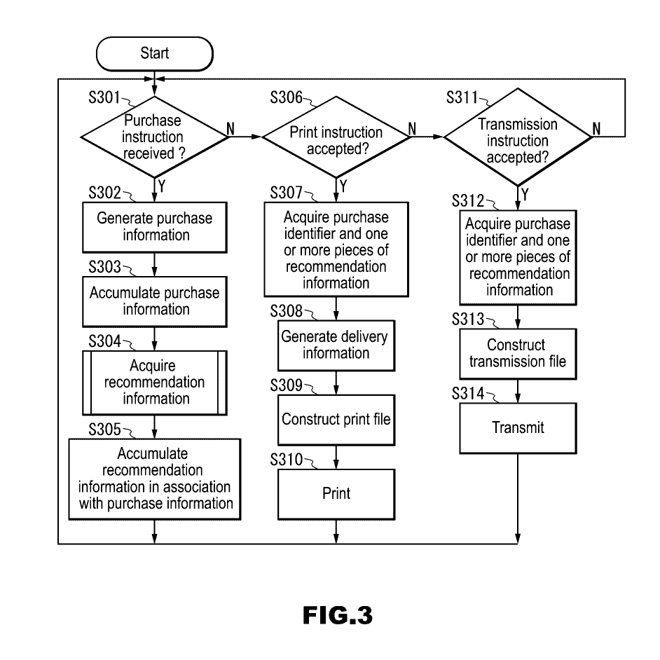

Next, an operation of the recommendation system will be described. First, an operation of the recommendation apparatus 1 will be described with reference to the flowchart in FIG. 3.

(Step S301) The receiving unit 14 determines whether or not it has received a purchase instruction from a terminal apparatus 2. If the receiving unit 14 has received a purchase instruction, the procedure advances to step S302, and, if not, the procedure advances to step S306.

(Step S302) The purchase information generating unit 15 generates purchase information, using the purchase instruction received in step S301.

(Step S303) The purchase information generating unit 15 accumulates the purchase information generated in step S302, in the purchase information storage unit 13.

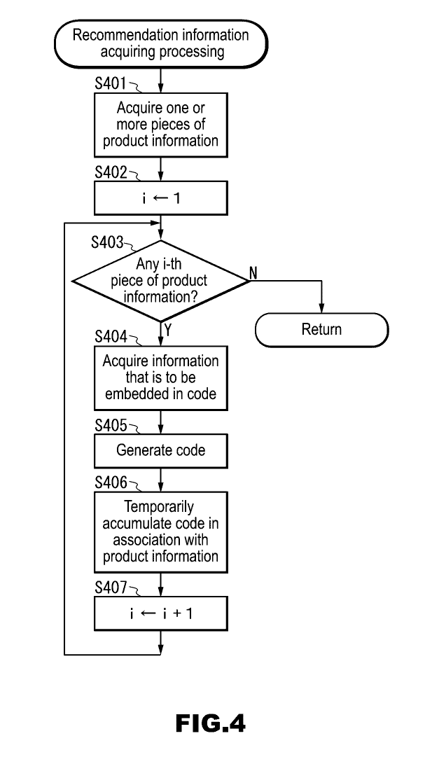

(Step S304) The recommendation information acquiring unit 17 acquires one or more pieces of recommendation information, using the purchase instruction. The recommendation information acquiring processing will be described with reference to the flowchart in FIG. 4.

(Step S305) The recommendation information acquiring unit 17 temporarily accumulates the one or more pieces of recommendation information acquired in step S304, in association with the purchase information generated in step S302, in the purchase information storage unit 13. The procedure returns to step S301.

(Step S306) The accepting unit 20 determines whether or not it has accepted a print instruction. If the accepting unit 20 has accepted a print instruction, the procedure advances to step S307, and, if not, the procedure advances to step S311.

(Step S307) The output unit 18 acquires a purchase identifier corresponding to the print instruction and one or more pieces of recommendation information corresponding to the print instruction. For example, the output unit 18 acquires one or more pieces of recommendation information from the purchase information storage unit 13. For example, the print instruction has a purchase identifier, and the output unit 18 acquires one or more pieces of recommendation information corresponding to that purchase identifier.

(Step S308) The delivery information generating unit 16 generates delivery information, using purchase information corresponding to the print instruction. For example, the delivery information generating unit 16 acquires purchase information corresponding to the print instruction, and generates delivery information, using one or at least two product identifiers or the like contained in that purchase information. The delivery information generating unit 16 inserts, for example, part of one or more pieces of purchase information (e.g., item number, product name, unit price, quantity, price, etc.) corresponding to the print instruction into a delivery slip form held by the delivery information generating unit 16, thereby generating information that forms a delivery slip.

(Step S309) The output unit 18 constructs a print file such that the one or more pieces of recommendation information acquired in step S307 and the purchase identifier corresponding to the print instruction are printed on a sheet of paper. The output unit 18 may also construct a print file for the delivery slip, using the delivery information generated in step S308. The output unit 18 may construct a print file such that the purchase identifier, the one or more pieces of recommendation information, and the delivery information are printed on a sheet of paper. The sheet of paper may be two or more sheets.

(Step S310) The output unit 18 prints the print file constructed in step S309. The output unit 18 may transmit the print file constructed in step S309, to a printing apparatus. The procedure returns to step S301.

(Step S311) The accepting unit 20 determines whether or not it has accepted a transmission instruction. If the accepting unit 20 has accepted a transmission instruction, the procedure advances to step S312, and, if not, the procedure returns to step S301.

(Step S312) The output unit 18 acquires a purchase identifier corresponding to the transmission instruction and one or more pieces of recommendation information corresponding to the transmission instruction. For example, the output unit 18 acquires one or more pieces of recommendation information from the purchase information storage unit 13. For example, the transmission instruction has a purchase identifier, and the output unit 18 acquires one or more pieces of recommendation information corresponding to that purchase identifier.

(Step S313) The output unit 18 constructs a transmission file such that the one or more pieces of recommendation information acquired in step S312 and the purchase identifier corresponding to the transmission instruction are recorded in one file.

(Step S314) The output unit 18 transmits the transmission file constructed in step S313, to the user. The procedure returns to step S301. The user is a user that is identified by a user identifier paired with the purchase identifier corresponding to the transmission instruction. The output unit 18 transmits the transmission file to the user, using notification destination information (e.g., e-mail address, or telephone number, etc.) paired with the user identifier paired with the purchase identifier corresponding to the transmission instruction.

Note that the procedure is terminated by powering off or an interruption at the end of the process in the flowchart in FIG. 3.

Next, the recommendation information acquiring processing in step S304 will be described with reference to the flowchart in FIG. 4.

(Step S401) The product information searching part 171 acquires one or more pieces of product information from the product information storage unit 11. The product information searching part 171 acquires one or more pieces of product information from the product information storage unit 11, for example, in accordance with a predetermined algorithm such as collaborative filtering.

(Step S402) The code generating part 172 substitutes 1 for a counter i.

(Step S403) The code generating part 172 determines whether or not there is an i^{-th} piece of product information, among the pieces of product information acquired in step S401. If there is an i^{-th} piece of product information, the procedure advances to step S404, and, if not, the procedure returns to the upper-level processing.

(Step S404) The code generating part 172 acquires information that is to be embedded in a code. The information that is to be embedded in a code is, for example, a product identifier contained in the i^{-th} piece of product information, and information indicating that a medium to which the recommendation information is to be output is paper. The information that is to be embedded in a code is, for example, a product identifier contained in the i^{-th} piece of product information, and information for identifying a medium (e.g., paper) to which the recommendation information is to be output. The information for identifying a medium to which the recommendation information is to be output is information unique to each medium, and is, for example, an ID generated by the code generating part 172.

(Step S405) The code generating part 172 generates a code, using the information acquired in step S404. A technique for generating a code in a state where information that is to be embedded has been determined is a known technique.

(Step S406) The recommendation information constructing part 173 temporarily accumulates the code generated in step S405, in association with the i^{-th} piece of product information.

(Step S407) The code generating part 172 increments the counter i by 1. The procedure returns to step S403.

Typically, a group of pairs of the product information and the code temporarily accumulated in step S406 is the recommendation information.

Next, an operation of each terminal apparatus 2 will be described. The terminal accepting unit 22 forming the terminal apparatus 2 accepts a webpage acquisition instruction to output a webpage for purchasing a product, from the user. Next, the terminal transmitting unit 24 transmits the webpage acquisition instruction, to a web server (it may be the recommendation apparatus 1). Next, the terminal receiving unit 25 receives a webpage corresponding to the acquisition instruction, and the terminal output unit 26 outputs that webpage.

Furthermore, the terminal accepting unit 22 accepts a product identifier of a product that is to be purchased, the quantity thereof, and the like, from the user who viewed the output webpage. Next, the terminal processing unit 23 constructs a purchase instruction, from the product identifier, the quantity, and the like accepted by the terminal accepting unit 22. The terminal transmitting unit 24 transmits the purchase instruction to the recommendation apparatus 1.

Hereinafter, a specific operation of the recommendation system in this embodiment will be described. FIG. 1 shows a conceptual diagram of the recommendation system.

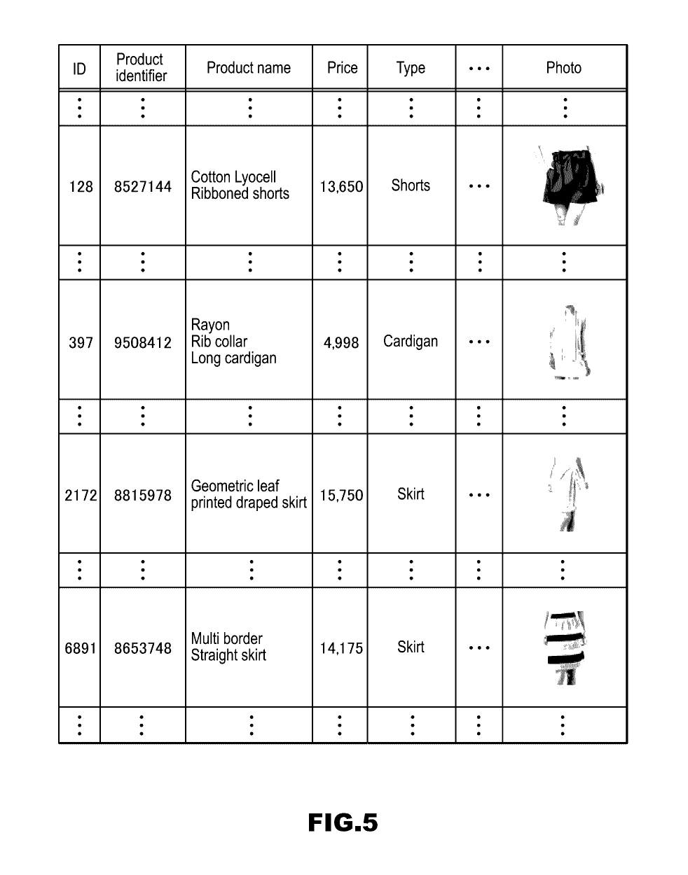

Now, the product information storage unit 11 holds the product information management table shown in FIG. 5. The product information management table manages records each having attribute values such as “ID”, “product identifier”, “product name”, “price”, “type”, and “photo”. In the table, “ID” is information for identifying a record, and “product identifier” in this example is a product number. Furthermore, “type” is the type of product, and “photo” is a photo of the product.

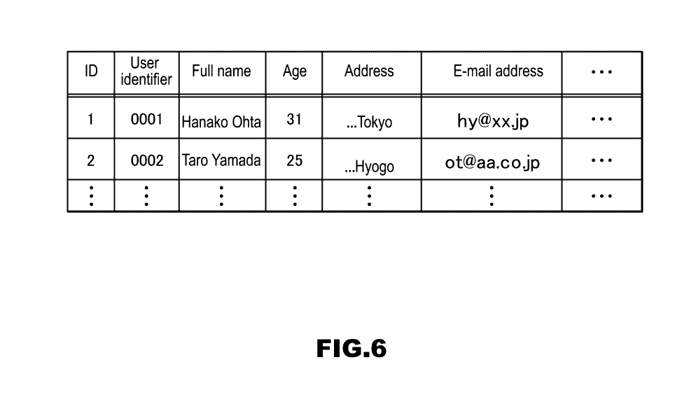

Furthermore, the user information storage unit 12 holds the user information management table shown in FIG. 6. The user information management table manages records each having attribute values such as “ID”, “user identifier”, “full name”, “age”, “address”, and “e-mail address”. In the table, “ID” is information for identifying a record.

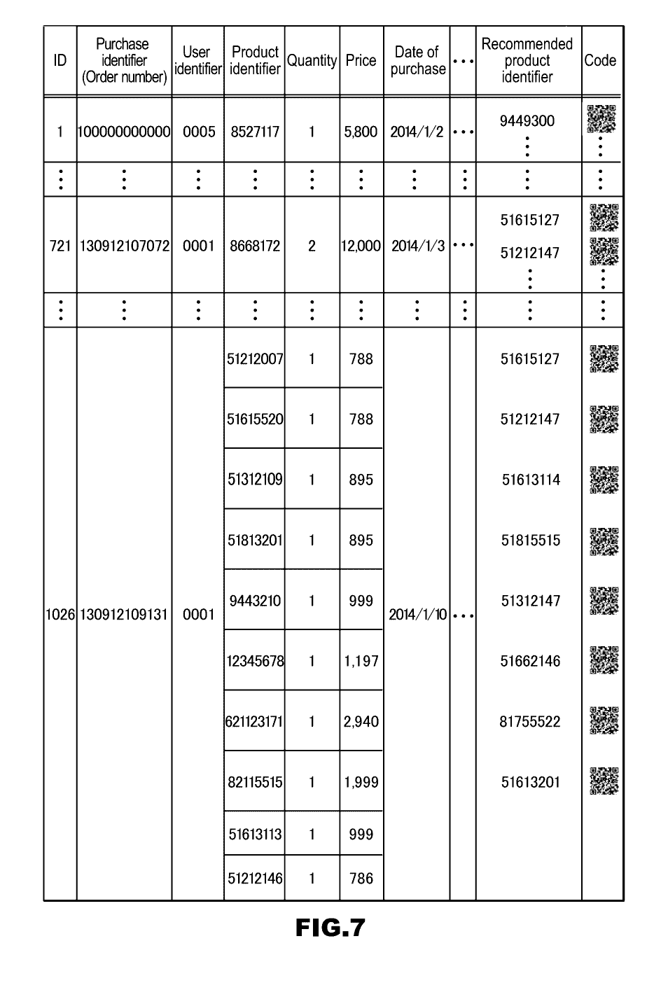

Moreover, the purchase information storage unit 13 holds the purchase information management table shown in FIG. 7. The purchase information management table manages records each having attribute values such as “ID”, “purchase identifier”, “user identifier”, “product identifier”, “quantity”, “price”, “date of purchase”, “recommended product identifier”, and “code”. In the table, “ID” is information for identifying a record. Furthermore, “quantity” is the quantity of purchased products, “price” is a price that is to be paid, and “recommended product identifier” is a product identifier of a product that is to be recommended. Note that there may be multiple sets of “product identifier”, “quantity”, and “price”, in one record. “Recommended product identifier” may have multiple recommended product identifiers, in one record. “Code” is associated with the recommended product identifier, and there may be multiple codes in one record. Furthermore, “purchase identifier” may be referred to as “order number”.

In this situation, it is assumed that a user “Hanako Ohta” (hereinafter, referred to as user A) caused her terminal apparatus 2 to output a webpage for purchasing clothes.

Then, it is assumed that the user A has selected ten products from the webpage, and has performed a purchase operation (touched a purchase button, etc.).

Next, the terminal accepting unit 22 forming the terminal apparatus 2 accepts product identifiers, the quantities, and the like of the ten products that have been purchased. Next, the terminal processing unit 23 constructs a purchase instruction, from the product identifiers, the quantities, and the like accepted by the terminal accepting unit 22. The terminal transmitting unit 24 transmits the purchase instruction to the recommendation apparatus 1.

Next, the receiving unit 14 forming the recommendation apparatus 1 receives the purchase instruction from the terminal apparatus 2. This purchase instruction contains the product identifiers and the quantities of the ten products, and the user identifier “0001”.

Next, the purchase information generating unit 15 generates purchase information, using the purchase instruction received by the receiving unit 14. First, it is assumed that the purchase information generating unit 15 generates a unique order number “130912109131”. Here, for example, the purchase information generating unit 15 generates a new order number by adding one to the latest order number. It is assumed that the latest order number is held by the purchase information generating unit 15. The purchase information generating unit 15 acquires the user identifier “0001” from the purchase instruction. The purchase information generating unit 15 acquires the product identifiers and the quantities from the purchase instruction. The purchase information generating unit 15 acquires product information from the product information management table, using each product identifier, and acquires a unit price from that product information. The purchase information generating unit 15 multiplies the unit price and the quantity, thereby calculating the price. The purchase information generating unit 15 acquires the date of purchase (current date). The purchase information generating unit 15 constructs purchase information, using these pieces of information. Next, the purchase information generating unit 15 accumulates the generated purchase information, in the purchase information management table. The purchase information is attribute values such as “ID”, “purchase identifier”, “user identifier”, “product identifier”, “quantity”, “price”, and “date of purchase”, in the record “ID=1026” in FIG. 7.

Next, the recommendation information acquiring unit 17 acquires one or more pieces of recommendation information, using the purchase instruction. That is to say, the product information searching part 171 forming the recommendation information acquiring unit 17 acquires one or more pieces of product information of products that are to be recommended to the user, using the purchase instruction, from the product information management table (FIG. 5). Next, the code generating part 172 acquires, for each piece of product information, information for identifying a product identifier, a medium (e.g., paper) to which the recommendation information is to be output, and the like. The code generating part 172 generates a code, using the acquired information. Next, the recommendation information constructing part 173 accumulates the product identifier contained in the product information and the generated code in association with the generated order number, in the purchase information management table (FIG. 7). The accumulated product identifier and code are “recommended product identifier” and “code”, in the record “ID=1026” in FIG. 7.

Next, it is assumed that a user on the administrator side of the recommendation apparatus 1 has input a print instruction having the order number “130912109131”, to the recommendation apparatus 1. Next, the accepting unit 20 accepts that print instruction.

Next, the output unit 18 acquires the purchase identifier “130912109131” from the print instruction. The output unit 18 acquires eight recommended product identifiers and eight codes corresponding to the purchase identifier “130912109131”, from the purchase information management table (FIG. 7). Furthermore, the output unit 18 acquires product names, prices, photos, and the like paired with product identifiers that respectively match the eight recommended product identifiers, from the product information management table (FIG. 5). In this example, eight pieces of recommendation information have been acquired. The recommendation information in this example has a recommended product identifier, a product name, a price, a photo, a code, and the like.

Furthermore, the delivery information generating unit 16 generates delivery information containing information regarding the ten purchased products, using the purchase information corresponding to the print instruction “130912109131”. It is assumed that the delivery information is, for example, detailed information regarding the order.

Next, the output unit 18 constructs a print file such that the acquired eight pieces of recommendation information and the purchase identifier corresponding to the print instruction are printed on a sheet of paper. In this case, the output unit 18 may construct a print file such that the purchase identifier, the one or more pieces of recommendation information, and the delivery information are printed on a sheet of paper.

Next, the output unit 18 prints the constructed print file. FIG. 8 shows a printing example. In FIG. 8, 81 denotes a purchase identifier (order number), 82 denotes recommendation information, and 83 denotes a code.

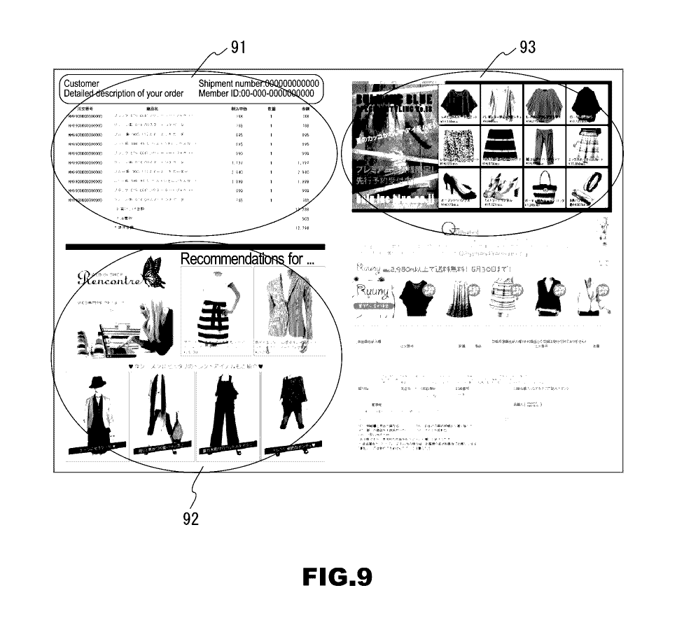

Furthermore, paper printed by the output unit 18 may be as shown in FIG. 9. In FIG. 9, the purchase identifier, the one or more pieces of recommendation information, and the delivery information are printed on a sheet of paper. In FIG. 9, 91 denotes delivery information, and 92 denotes one or more pieces of recommendation information. Furthermore, 93 denotes an advertisement, and is information shared by all users (all sheets of paper).

It is preferable that the paper printed by the output unit 18 is packed together with the products purchased by the user. Accordingly, the user sees the recommendation information (flyer) when the user is at his or her happiest moment receiving the products. If the printed paper is packed together with the products, the probability of the recommendation information (flyer) being seen by the user is high. If the recommendation information is printed on the delivery slip, or if the recommendation information is printed on a flyer packed together with the products, the probability of the recommendation information being seen by the user is extremely high. Accordingly, the probability of the user making another purchase increases.

Furthermore, since the purchase identifier such as an order number and the recommendation information are printed on a sheet of paper, a packing operator can correctly pack the sheet of paper and the products together when shipping the products.

As described above, according to this embodiment, it is possible to effectively recommend products.

Moreover, specifically, according to this embodiment, since the recommendation information can be output to a medium (e.g., paper medium, etc.) that is different from a medium (typically, a webpage) to which the purchase instruction was input, products can be effectively recommended.

Furthermore, according to this embodiment, since a purchase identifier such as an order number and one or more pieces of recommendation information can be printed in association with each other, a packing operator can correctly pack the printed sheet of paper together with a product that is to be sent.

The technique in this embodiment can be said to be a technique obtained by combining a first medium (typically, webpage) to which a purchase instruction was input and a second medium that is different from the first medium. More specifically, the technique in this embodiment can be said to be a technique obtained by combining, for example, a first medium that is a webpage and a second medium that is paper.

Furthermore, according to this embodiment, the recommendation apparatus 1 can output recommendation information having a code. The code typically includes one or more types of information, among information indicating that a medium is an output medium, which is a medium to which recommendation information is to be output, an output medium identifier for identifying an output medium to which recommendation information is to be output, a purchase information identifier for identifying purchase information, and a user identifier for identifying a user. If the code is read by a user's terminal (e.g., smartphone), a webpage for purchasing a product corresponding to the code is output, so that the user can easily purchase recommended products. Accordingly, the technique in this embodiment can be said to be a technique for spirally shifting from a first medium (typically, a webpage) to a second medium (e.g., paper) and further to the first medium (typically, a webpage).

Furthermore, with a mechanism using such a code, a provider or a marketer of a product can see via which route the product was purchased by a user. The route is paper on which recommendation information is printed, a web advertisement, or the like. Thus, with the mechanism using such a code, the recommendation apparatus 1 can check the effect of output recommendation information, thereby contributing to an improvement in the quality of recommendation. For improvement in the quality of recommendation, feedback from users is necessary, and the code in this embodiment can also be used for this purpose. According to the specific example of this embodiment, the purchase information and the one or more pieces of recommendation information are output by being printed on the same sheet of paper. However, the purchase information and the one or more pieces of recommendation information may be output by being transmitted to a user. That is to say, for example, the output unit 18 may transmit the file in FIG. 8 or 9 to a user.

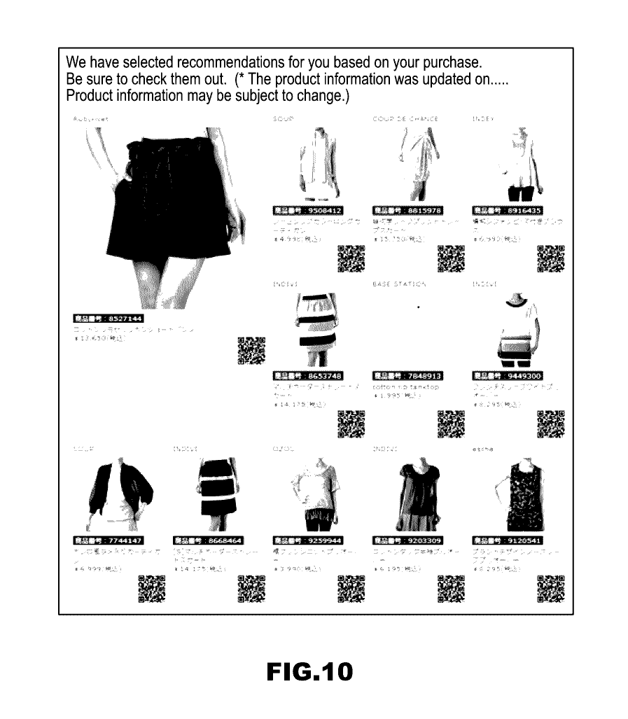

Furthermore, according to this embodiment, the purchase information and the one or more pieces of recommendation information are output in association with each other. However, the output unit 18 may output one or more pieces of recommendation information to a medium that is different from a medium to which the purchase instruction was input, in a state where the purchase information and the one or more pieces of recommendation information are not associated with each other. For example, a file (e.g., a PDF file) of one or more pieces of recommendation information as shown in FIG. 10 may be transmitted by e-mail to a user. The file shown in FIG. 10 has no purchase information identifier.

The processing in this embodiment may be realized by software. The software may be distributed by software downloads or the like. Furthermore, the software may be distributed in a form where the software is stored in a storage medium such as a CD-ROM. Note that the same is applied to other embodiments described in this specification. The software that realizes the recommendation system in this embodiment may be the following sort of program. Specifically, this program is a program for causing a computer to function as: a receiving unit that receives a purchase instruction having a user identifier for identifying a user and a product identifier for identifying a product that is to be purchased; a purchase information generating unit that generates purchase information, which is information related to a purchase of a product, using the purchase instruction; a recommendation information acquiring unit that acquires one or more pieces of recommendation information, which is information related to a product that is to be recommended to the user, using the purchase instruction; and an output unit that outputs the purchase information and the one or more pieces of recommendation information in association with each other.

Furthermore, it is preferable that the program causes the computer to operate such that the output unit outputs the one or more pieces of recommendation information to a medium that is different from a medium to which the purchase instruction was input.

Furthermore, it is preferable that the program causes the computer to operate such that the purchase information generating unit generates purchase information containing a purchase identifier for identifying a purchase of a product corresponding to the purchase instruction, and the output unit outputs the purchase identifier and the one or more pieces of recommendation information in association with each other.

Furthermore, it is preferable that the program causes the computer to operate such that the output unit prints the purchase identifier and the one or more pieces of recommendation information, on the same sheet of paper.

Furthermore, it is preferable that the program causes the computer to operate such that the recommendation information contains a code indicating information for identifying a product.

Furthermore, it is preferable that the program causes the computer to operate such that the code includes one or more types of information, among information indicating that a medium is an output medium, which is a medium to which recommendation information is to be output, an output medium identifier for identifying an output medium to which recommendation information is to be output, a purchase information identifier for identifying purchase information, and a user identifier for identifying a user, and, in a case where the code is read, a webpage for purchasing a product corresponding to the code is output.

Furthermore, it is preferable that the program causes the computer to further function as: a delivery information generating unit that generates delivery information, which is information related to a delivery, using the purchase instruction, wherein the output unit outputs the purchase identifier and the one or more pieces of recommendation information in association with each other, and outputs the delivery information.

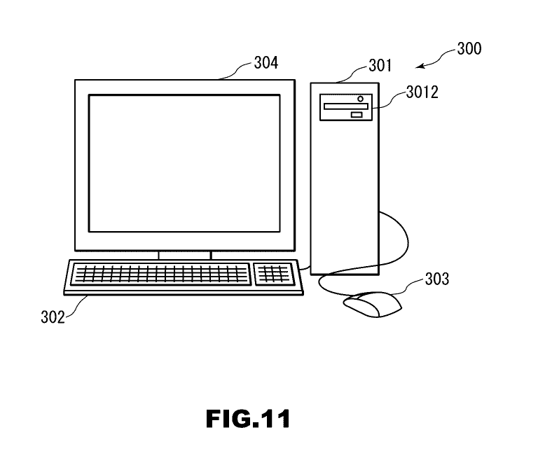

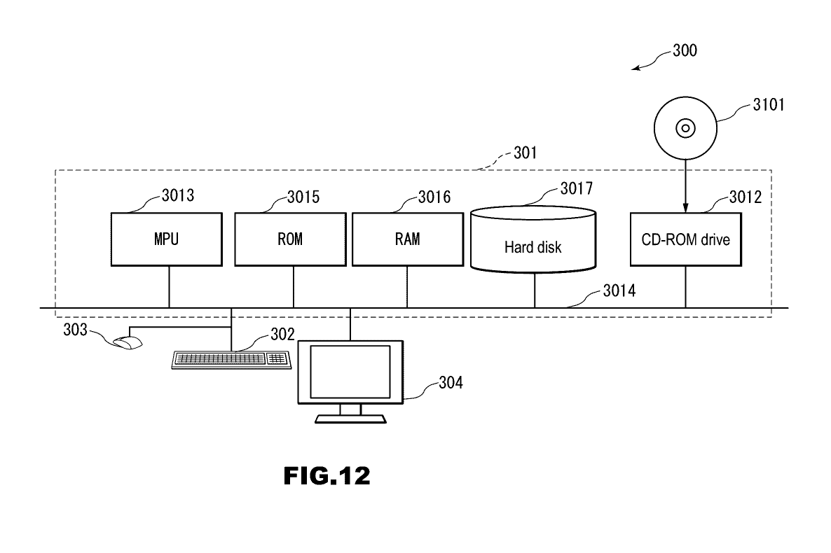

FIG. 11 shows the external appearance of a computer that executes the programs described in this specification to realize the recommendation apparatus in the foregoing various embodiments. The foregoing embodiments may be realized using computer hardware and a computer program executed thereon. FIG. 11 is a schematic view of a computer system 300. FIG. 12 is a block diagram of the system 300.

In FIG. 11, the computer system 300 includes a computer 301 including a CD-ROM drive, a keyboard 302, a mouse 303, and a monitor 304.

In FIG. 12, the computer 301 includes not only the CD-ROM drive 3012, but also an MPU 3013, a bus 3014 connected to the MPU 3013 and the CD-ROM drive 3012, a ROM 3015 in which a program such as a boot up program is to be stored, a RAM 3016 that is connected to the MPU 3013 and is a memory in which a command of an application program is temporarily stored and a temporary storage area is provided, and a hard disk 3017 in which an application program, a system program, and data are to be stored. Although not shown, the computer 301 may further include a network card that provides connection to a LAN.

The program for causing the computer system 300 to execute the functions of the recommendation apparatus in the foregoing embodiments may be stored in a CD-ROM 3101 that is inserted into the CD-ROM drive 3012, and be transmitted to the hard disk 3017. Alternatively, the program may be transmitted via a network (not shown) to the computer 301 and stored in the hard disk 3017. At the time of execution, the program is loaded into the RAM 3016. The program may be loaded from the CD-ROM 3101, or directly from a network.

The program does not necessarily have to include, for example, an operating system (OS) or a third party program to cause the computer 301 to execute the functions of the recommendation apparatus in the foregoing embodiments. The program may only include a command portion to call an appropriate function (module) in a controlled mode and obtain the desired results. The manner in which the computer system 300 operates is well known, and, thus, a detailed description thereof has been omitted.

It should be noted that, in the program, in a transmitting step of transmitting information, a receiving step of receiving information, or the like, processing that is performed by hardware, for example, processing performed by a modem or an interface card in the transmitting step (processing that can be performed only by hardware) is not included.

Furthermore, the computer that executes this program may be a single computer, or may be multiple computers. That is to say, centralized processing may be performed, or distributed processing may be performed.

Furthermore, in the foregoing embodiments, it will be appreciated that two or more communication parts in one apparatus may be physically realized by one medium.

Furthermore, in the foregoing embodiments, each process or each function may be realized as centralized processing using a single apparatus or a single system, or may be realized as distributed processing using multiple apparatuses.

Note that the invention of the present application is not limited to the embodiments set forth herein and may be variously modified in practice without departing from the gist of the present invention, and such modifications are also encompassed in the scope of the invention.

Furthermore, the foregoing embodiments include inventions in various stages of the present invention, and various inventions can be extracted by appropriately combining multiple constituent elements disclosed therein. For example, if the problems described in “Technical Problem” can be solved and the effects described in “Advantageous Effects of Invention” can be obtained even in the case where some constituent elements are deleted from all constituent elements described in the embodiments, configurations in which these constituent elements are deleted are extracted as the inventions.

### INDUSTRIAL APPLICABILITY

As described above, the recommendation apparatus according to the present invention has an effect that products can be effectively recommended, and, thus, this apparatus is useful as a printing apparatus for printing recommendation information, and the like.

### LIST OF REFERENCE NUMERALS

1 Recommendation apparatus

2 Terminal apparatus

11 Product information storage unit

12 User information storage unit

13 Purchase information storage unit

14 Receiving unit

15 Purchase information generating unit

16 Delivery information generating unit

17 Recommendation information acquiring unit

18 Output unit

19 Transmitting unit

20 Accepting unit

21 Terminal storage unit

22 Terminal accepting unit

23 Terminal processing unit

24 Terminal transmitting unit

25 Terminal receiving unit

26 Terminal output unit

171 Product information searching part

172 Code generating part

173 Recommendation information constructing part

1. A recommendation apparatus comprising:
a receiving unit that receives a purchase instruction having a user identifier for identifying a user and a product identifier for identifying a product that is to be purchased;
a purchase information generating unit that generates purchase information, which is information related to a purchase of a product, using the purchase instruction;
a recommendation information acquiring unit that acquires one or more pieces of recommendation information, which is information related to a product that is to be recommended to the user, using the purchase instruction; and
an output unit that outputs the purchase information and the one or more pieces of recommendation information in association with each other,
wherein the output unit outputs the one or more pieces of recommendation information to a medium that is different from a medium to which the purchase instruction was input.

2. The recommendation apparatus according to claim 1,
wherein the purchase information generating unit generates purchase information containing a purchase identifier for identifying a purchase of a product corresponding to the purchase instruction, and
the output unit outputs the purchase identifier and the one or more pieces of recommendation information in association with each other.

3. The recommendation apparatus according to claim 2, wherein the output unit prints the purchase identifier and the one or more pieces of recommendation information, on the same sheet of paper.

4. The recommendation apparatus according to claim 1, wherein the recommendation information contains a code indicating information for identifying a product.

5. The recommendation apparatus according to claim 4,
wherein the code includes one or more types of information, among information indicating that a medium is an output medium, which is a medium to which recommendation information is to be output, an output medium identifier for identifying an output medium to which recommendation information is to be output, a purchase information identifier for identifying purchase information, and a user identifier for identifying a user, and
in a case where the code is read, a webpage for purchasing a product corresponding to the code is output.

6. The recommendation apparatus according to claim 1, further comprising:
a delivery information generating unit that generates delivery information, which is information related to a delivery, using the purchase instruction,
wherein the output unit outputs the purchase identifier and the one or more pieces of recommendation information in association with each other, and outputs the delivery information.

7. A recommendation method realized by a receiving unit, a purchase information generating unit, a recommendation information acquiring unit, and an output unit, comprising:
a receiving step of the receiving unit receiving a purchase instruction having a user identifier for identifying a user and a product identifier for identifying a product that is to be purchased;
a purchase information generating step of the purchase information generating unit generating purchase information, which is information related to a purchase of a product, using the purchase instruction;
a recommendation information acquiring step of the recommendation information acquiring unit acquiring one or more pieces of recommendation information, which is information related to a product that is to be recommended to the user, using the purchase instruction; and
an output step of the output unit outputting the purchase information and the one or more pieces of recommendation information in association with each other,
wherein, in the output step, the one or more pieces of recommendation information are output to a medium that is different from a medium to which the purchase instruction was input.

8. A recommendation medium producing method realized by a receiving unit, a purchase information generating unit, a recommendation information acquiring unit, and an output unit, comprising:
a receiving step of the receiving unit receiving a purchase instruction having a user identifier for identifying a user and a product identifier for identifying a product that is to be purchased, the purchase instruction being based on information input from a webpage;
a purchase information generating step of the purchase information generating unit generating purchase information, which is information related to a purchase of a product, using the purchase instruction;
a recommendation information acquiring step of the recommendation information acquiring unit acquiring one or more pieces of recommendation information, which is information related to a product that is to be recommended to the user, using the purchase instruction; and
an output step of the output unit printing the purchase information and the one or more pieces of recommendation information in association with each other, thereby producing a recommendation medium that is a sheet of paper on which the one or more pieces of recommendation information are printed.
